(19) United States
(12) Patent Application Publication
(10) Pub. No.: US 2025/0326307 A1
(43) Pub. Date: Oct. 23, 2025

(54) Vehicle as a Charger (VAAC) Charging System and Method

(71) Applicant: BarrellCharge Solutions, Inc., Austin, TX (US)

(72) Inventors: Murray F. Freeman, Austin, TX (US); Steven A. Tarnowsky, West Bloomfield, MI (US); William D. Marsh, Austin, TX (US)

(21) Appl. No.: 19/169,163

(22) Filed: Apr. 3, 2025

Related U.S. Application Data
(60) Provisional application No. 63/635,125, filed on Apr. 17, 2024.

(51) Int. Cl. B60L 53/16; B60L 53/10; B60L 53/53; B60L 55/00

(52) U.S. Cl. CPC B60L 53/16; B60L 53/11; B60L 53/53; B60L 55/00; B60L 2210/30; B60L 2210/40

(57) ABSTRACT

Various embodiments of a charging system for charging an electric vehicle (EV) are disclosed. One embodiment, among others, is charging system in the form of an EV. The EV has (1) an electric propulsion, direct current (DC) battery pack designed to provide electrical power to a plurality of electric motors for propulsion of the EV; (2) a DC charging port that is connected to the DC battery pack; (3) an alternating current (AC) charging port connected to a single-phase AC power grid associated with a utility service provider; (4) an on-board charger module (OBCM) connected to the AC charging port and the battery pack and providing DC power to the battery pack from the AC power grid; A point-of-sale (PoS) dispenser receives DC power from the DC charging port. The dispenser has a coupler that is connectable to and dis-connectable from an EV to be charged.

### CLAIM OF PRIORITY

This application claims priority to and the benefit of U.S. Patent Application entitled “Vehicle as a Charger (VAAC) Charging System and Methods,” filed on Apr. 17, 2024, under application No. 63/635,125, which is incorporated herein by reference in its entirety.

### FIELD OF THE INVENTION

The embodiments of the present disclosure generally relate to charging stations, or systems, for electric vehicles (EVs), and more particularly, to the use of an EV as a charger for another EV.

### BACKGROUND OF THE INVENTION

Electric vehicle supply equipment (EVSE) supplies electricity to an electric vehicle (EV). Commonly called charging stations or charging docks, they provide electric power to the EV and use that to recharge the EV's batteries. EVSE systems include the electrical conductors, related equipment, software, and communications protocols that deliver energy efficiently and safely to the vehicle. In general, EVSE equipment is classified as Level 1 (120 volts AC), Level 2 (240 volts, AC), and DC Fast Charger (480 volts DC and higher).

As battery EV market penetration increases, there will be growing demand for public charging, especially at power levels that can provide at least 30 miles of vehicle range in 10 minutes. Without power grid buffering, the amount of EV charging power required to achieve this “fast charging” (50 KW or above) would typically be provided by a 3-phase, 480 V grid service. This type of grid service is generally available at large-scale industrial sites for continuous, high-power needs.

However, for most residential, retail, and light industrial sites, power grid service is typically provided by single-phase 240 V AC that is power limited to less than 50 KW. For those site owners that would like to offer EV charging at greater than 50 KW, they could upgrade their grid service to 3-phase 480 V AC by working with their local electric utility company, but this unfortunately can be expensive and have a long lead time.

### SUMMARY OF THE INVENTION

Various embodiments of a vehicle as a charger (VAAC) charging system are disclosed for using an electric vehicle (EV) as a charger for charging another EV.

One embodiment, among others, can be summarized as follows. The charging system is implemented in the form of an EV, called a “doner EV” herein. The doner EV has (1) an electric propulsion, direct current (DC) battery pack designed to provide electrical power to a plurality of electric motors for propulsion of the EV; (2) a DC charging port that is connected to the DC battery pack; (3) an alternating current (AC) charging port connected to a single-phase AC power grid associated with a utility service provider; (4) an AC to DC converter, for example, an on-board charger module (OBCM), connected to the AC charging port and the battery pack and is capable of providing DC power to the battery pack from the AC power grid. A point-of-sale (POS) dispenser is capable of receiving DC power from the DC charging port. The dispenser has a coupler that is connectable to and dis-connectable from an EV to be charged. In some variations of embodiments, the AC port is capable of reversing the mode of operation to provide AC power back to the AC power grid from DC power from the converter and the battery pack.

Another embodiment, among others, is a method, comprising the steps of: providing first and second electric vehicles at a location; communicating energy from a single-phase alternating current (AC) power grid provided by a utility service provider to a first propulsion, direct current (DC) battery pack of the first electric vehicle (EV); and communicating DC power from the first propulsion DC battery pack to a second propulsion DC battery pack of the second EV, which is to be charged. In some other variations of embodiments, the method may further comprise the step of communicating energy to the power grid from the DC battery pack of the first EV.

Other embodiments, systems, apparatus, methods, features, and advantages of the present invention will be apparent to one with skill in the art upon examination of the following drawings and detailed description. It is intended that all such additional embodiments, systems, apparatus, methods, features, and advantages be included within this disclosure, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a high-level block diagram of the VAAC charging system of the present disclosure.

FIG. 2 is a more detailed block diagram of the VAAC charging system of FIG. 1 showing the integration of a VAAC conversion kit in a donor EV being used as a charger.

FIG. 3 shows a functional context diagram for the VAAC charging system of FIG. 1.

FIG. 4 shows the decomposition of the Store & Deliver Energy function to its sub-functions. The VAAC sub-functions are shown within the dotted oval while interfacing entities are shown outside the oval.

FIG. 5 is a flow chart of a method for charging that is implemented by the VAAC charging system of FIGS. 1 and 2.

### DETAILED DESCRIPTION OF PREFERRED EMBODIMENT(S)

The VAAC charging system of the present disclosure can perform at least the following high-level functions: (1) take a single-phase, high voltage AC power electric grid connection input, store the accumulated energy, and convert that energy to output DC high voltage power; and (2) take high voltage DC power from a connected source and convert that energy to provide a high voltage AC power output.

While EV to EV charging capability is now available with some production vehicles in some markets, it is limited to relatively low, high voltage AC power transfers via bi-directional, on-board charge modules. In this case, additional hardware is limited to a coupler/cable assembly that is small, light, and easy to store on a vehicle. To transfer high power between EVs, it would be most efficiently done via DC to DC conversion which would require a dedicated DC/DC converter that gets heavier, larger, and more expensive as power levels increase. To transfer power at 50 kW or above, the required DC/DC converter becomes prohibitively too large and heavy to practically carry around on-board.

The VAAC charging system of the present disclosure exploits this undesirable practicality by converting a doner EV into a dedicated DC fast charger, enabling high power energy transfers between “vehicles” with the doner EV being unencumbered by also having to simultaneously provide transportation.

In addition, the VAAC charging system exploits the high volume, high quality and low cost of automotive grade components by repurposing and reusing them for EV charging functionality, minimizing the need for custom-designed components. The VAAC also provides second-use opportunity for key EV components. Finally, the VAAC is unique in its ability to both be charging via power grid connection while simultaneously charging another EV (or vice versa).

The preferred embodiment can be used to enable a relatively low-power, single-phase AC utility connection to DC fast charge an EV at relatively high-power. “EV” in the context of this document, can also include a hybrid vehicle that also uses gasoline or diesel fuel. In a mobile application, the VAAC charging system could also charge an EV (or be charged by one) for a limited time without any grid input connection. The DC output power could also be used for other purposes, including being a source of power in a distributed energy resource system (DERS). If the electric grid fails, then the VAAC charging system can be used in reverse to provide an AC output back to the site owner for emergency backup or back to the grid for improved resiliency.

Although there are other EV charging systems currently available in the market that can provide the functions described above, they are all optimized to perform the EV charging function by dedicating their hardware and software towards that purpose. The VAAC charging system approach is unique in that it repurposes a doner EV with supplementary hardware, software, and modifications to become an EV DC fast charger in its preferred embodiment.

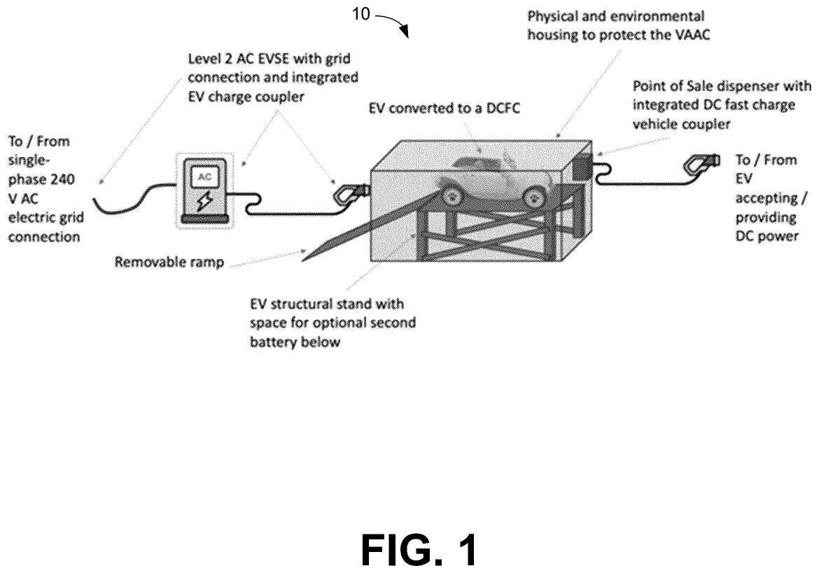

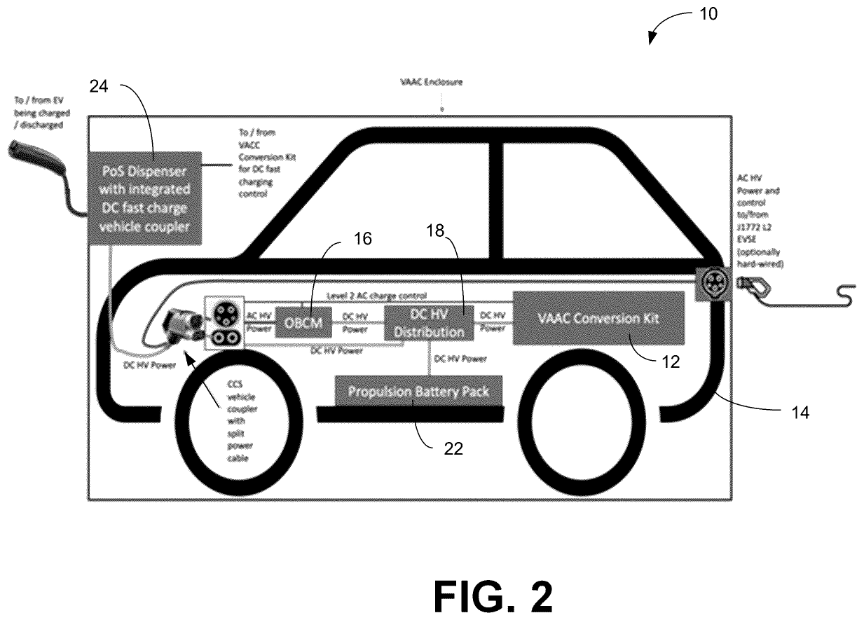

A high-level architectural block diagram of the VAAC charging system is shown in FIG. 1 and denoted by reference numeral 10. A more detailed block diagram showing the integration of a VAAC charging system conversion kit 12 in a donor EV 14 being used as a charger is shown in FIG. 2. The On-Board Charge Module (OBCM) 16, DC HV Distribution system 18, and Propulsion Battery Pack 22 indicate key vehicle components being repurposed for DC fast charging applications. The PoS Dispenser 24 with integrated DC fast charge vehicle coupler and the VAAC Conversion Kit 14 indicate new VAAC charging system components. The preferred embodiment shown uses a modified standard combined charging system (CCS) connector to exploit repurposing a vehicle charge port by splitting AC and DC components for simplified enablement of charging the VAAC charging system battery with AC simultaneously with discharging the VAAC charging system battery with DC power. The modified connector is a splitter that physically mounts on the CCS port and electrically separates the DC and AC charging ports.

The CCS standard is described at the following URL address: https://en.wikipedia.org/wiki/Combined_Charging_System, which is incorporated herein by reference. However, any standard combined coupler/port can be used or the vehicle port can be eliminated altogether and dedicated AC and DC connections could be made to achieve the same purpose.

Note that the donor EV 14 can have some of its parts removed, for example but not limited to, its tires in order to prevent tire dry rot, without comprising the VAAC charging system 10, and while enabling the donor EV 14 to be easily converted back to a substantially functioning and movable EV.

Key components of the VAAC charging system 10 can be grouped into two categories consisting of either repurposed doner EV components or new components making up the VAAC charging system conversion kit 12.

### Doner EV Components

Vehicle Propulsion Battery Pack—Although not limited to this implementation, the donor EV of the preferred embodiment is a Bolt that is commercially available and can be purchased from General Motors or on the secondary market. The vehicle propulsion battery pack of the donor EV can be repurposed from vehicle propulsion to DC fast charging another EV. It also has a secondary use as the doner EV can be retained via reconfiguration should the need arise to physically relocate the VAAC charging system.

Vehicle Supervisory Controller and Controls—Existing vehicle supervisory controller and controls continue to provide primary doner EV state controls as directed by the new VAAC charging system supervisory controls via communication with the new VAAC charging system gateway controller.

On-Board Charge Module—An on-board charger module (OBCM), or an AC to DC converter, maintains its original and primary function of Level 2 charging the doner EV's propulsion battery pack from a high voltage (HV) AC source when the power grid is connected. The OBCM could also be bidirectional, allowing the additional functionality of the stored doner EV energy to be converted back to AC grid energy.

Vehicle Thermal Management System—A battery thermal management system maintains its original and primary function of thermally managing the doner EV's propulsion battery. However, in this VAAC charging system application, battery use will generally be different (Level 2 charging from the grid and fast discharging when the power is being used to charge another EV).

Low Voltage Wiring Harness—A low voltage wiring harness maintains its original and primary functions, but will be disconnected and subsequently reconnected to the VAAC low voltage wiring harness to provide VAAC-specific functionality.

High Voltage, High Power Distribution And Cabling—High voltage, high power distribution and cabling is also provided. When operating as a DC fast charger, the HV DC power connection to the doner EV's drive inverter will be disconnected and re-routed to the VAAC DC/DC converter for subsequent delivery of DC fast charge power to the EV being charged. If the Doner EV needs to be physically driven again, then the drive inverter can be reconnected to restore the propulsion function.

### VAAC Conversion Kit Components

Point-of-Sale (POS) Dispenser With Integrated DC Fast Charge Vehicle Coupler—
a. PoS Device—A PoS Device performs financial transaction associated with the purchase (sale) of energy being used to charge (discharge) a customer's EV.
b. User Display—A user display communicates the required operability steps a customer will need to successfully interact with the VAAC.
C. DC Fast Charge Vehicle Coupler—A DC Fast Charge Vehicle Coupler is provided and is a physical connector (with power cable) that the EV charging (discharging) customer will connect to their EV to receive (donate) energy from (to) the VAAC. The coupler of the dispenser is connectable to and dis-connectable from the EV to be charged.

Structural Stand—Optionally, a structural stand can be used to secure the doner EV above the ground to allow for space below for an optional, second battery pack to increase both the amount of VAAC stored energy and power capability. The second battery pack is connected in parallel with the doner EV battery pack. If the structural stand is used, then a removable ramp will also be provided to facilitate the positioning of the doner EV onto the structural stand.

Enclosure—In some embodiments, an enclosure can be used to enclose the donor EV in order to provide environmental protection of the doner EV and many of the VAAC conversion kit components when the VAAC is installed at a site in a stationary application.

Supplemental Thermal Management—Supplemental thermal management apparatus can provide a nominal operating environment for the doner EV and key VAAC components during operation. Such apparatus may include, for example but not limited to, a fan for cooling components.

Mobile Trailer Kit—A mobile trailer kit may also be provided. More specifically, DC fast charging functionality may be desired at sites where there is no available power grid connection. In this case, the VAAC charging system (with or without the enclosure, structural stand and supplemental thermal management system) may be loaded into the optional mobile trailer kit for towing to the desired site. Operation would then be limited to the stored energy in the doner EV. When depleted, the VAAC would be towed back to a site where the doner EV battery could be charged.

DC/DC Converter—A DC to DC (DC/DC) converter is provided to enable high voltage, high power conversion of the doner EV's propulsion battery pack stored energy to power that is transferred to (or from) the customer EV being charged (or discharged).

Power Cabling—High Voltage DC and AC power cabling is provided as a supplement to what is already in the doner EV, but is recommended or required for VAAC functionality.

Supplemental Low Voltage Harness—A supplemental low voltage wiring harness is provided that is supplemental to what is already in the doner EV but is required for VAAC internal data and control functionality.

Communications Module—A communications module, preferably one that is in compliance with the 5G communications standard, is provided to enable wireless data communications and control functionality between the VAAC charging system and third parties.

EV Charging Controls—EV charging controls, which may or may not include a dedicated controller, manage all transfer of energy between the VAAC charging system and the electric utility grid, as well as between the VAAC charging system and a customer EV.

Gateway Controls—Gateway controls, which may or may not include a dedicated controller, manage all data and control communications between the doner EV and the VAAC-specific functionality. This implementation maximizes reuse of doner EV controls without modification.

VAAC Supervisory Controls—VAAC supervisory controls, which may or may not include a dedicated controller, manage all data and control necessary for VAAC-specific functionality.

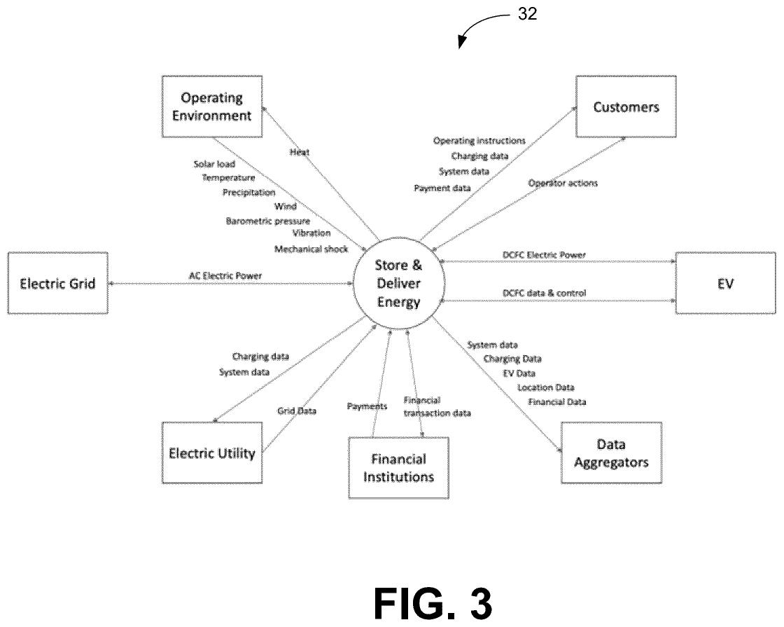

FIG. 3 shows a functional context diagram 32 for the VAAC charging system 10. The VAAC charging system function is shown within the circle while interfacing entities are shown outside the circle. A primary function of the VAAC charging system 10 is to store and delivery energy. Energy transfer can be to the EV being charged or to the electric grid.

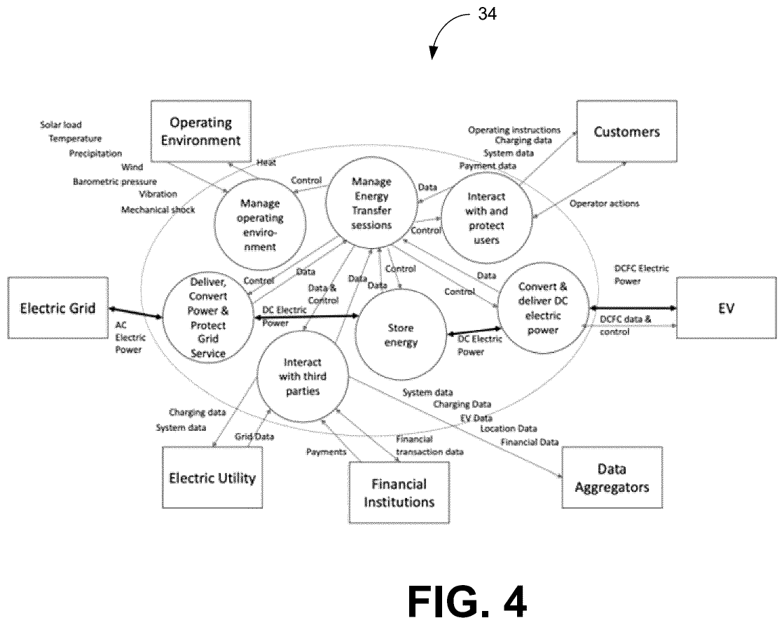

FIG. 4 shows a decomposition diagram 34 of the “Store & Deliver Energy” function to its sub-functions. The VAAC charging system sub-functions are shown within the dotted oval while interfacing entities are shown outside the oval.

Each of the VAAC charging system sub-functions are mapped to the specific VAAC components as shown in Table 1 below.

TABLE 1
Mapping of VAAC Charging System Components To Sub-Functions

| | | VAAc Sub-Functions | | | | | | |
|---|---|---|---|---|---|---|---|---|
| | | Deliver, | | Manage | Interact | Convert & | | |
| | | [symbol] Protect | Manage | Energy | [symbol] | Deliver DC | | Interact |
| Conversion | | Grid | Operating | Transfer | Protect | Electric | Store | with 3rd |
| Paragraph # | Conversion Kit Comparant | Service | Environment | Sessions | Users | Power | Energy | Parties |
| [0030] | POS Device | | | | | | | X |
| [0031] | User Display | | | | | | | X |
| [0032] | [symbol] | | | | | | | X |
| [0033] | Structural Stand | | X | | | | | |
| [0034] | Enclosure | | X | | | | | |
| [0035] | Supplemental [symbol] Management | | X | | | | | |
| [0036] | Mobile Trailer Kit | N/A | N/A | N/A | N/A | N/A | N/A | N/A |
| [0037] | OC/OC Converter | | | | | X | | |
| [0038] | Power [symbol] | X | | | | X | | |
| [0039] | Supplemental Low | X | X | X | X | X | X | X |
| | Voltage Harness | | | | | | | |
| [0040] | [symbol] Communications Module | | | | X | | | |
| [0041] | [symbol] | | | X | | | | |
| [0042] | Gateway Controls | X | X | X | X | X | X | X |
| [0043] | [symbol] Supervisory Controls | X | X | X | X | X | X | X |
| Repurposed | | | | | | | | |
| Doner [symbol] | Repurpose Doner | | | | | | | |
| Paragraph # | EV Component | | | | | | | |
| [0024] | Vehicle Propulsions Battery Pack | | | | | | X | |
| [0025] | Vehicle Supervisory Controller | | | X | | | | |
| | and Controls | | | | | | | |
| [0026] | On-Board Charges Module | X | | | | | | |
| [0027] | Vehicle Thermal Management | | X | | | | | |
| | System | | | | | | | |
| [0028] | Loww Voltage Wiring Harness | X | X | X | X | X | X | X |
| [0029] | High Voltage, High Power | X | | | | X | X | |
| | Distribution and [symbol] | | | | | | | |

[symbol]

indicates data missing or illegible when filed

### Method for Charging

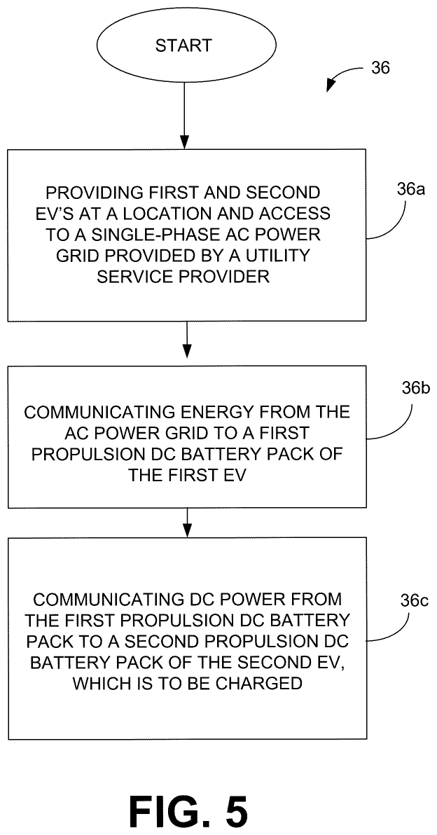

As shown in FIG. 5, an embodiment, among others, for a method 36 for charging practiced by the VAAC charging system 10 can be summarized as follows: providing first and second electric vehicles at a location (step 36a); communicating energy from a single-phase alternating current (AC) power grid provided by a utility service provider to a first propulsion, direct current (DC) battery pack of the first electric vehicle (step 36b); and communicating DC power from the first propulsion DC battery pack to a second propulsion DC battery pack of the second EV, which is to be charged (step 36c).

In some other embodiments, the foregoing method 36 may further comprise the steps of: communicating energy to the power grid from the DC battery pack of the first EV; providing a supplemental propulsion DC battery pack at the location; and communicating DC power from the supplemental propulsion DC battery pack to the second propulsion DC battery pack of the second EV.

In some other embodiments, the foregoing method 36 may further comprise the steps of: disconnecting the EV from the AC power source provided by the utility service; driving the EV to a new location; connecting the EV to a second single-phase AC power source provided by the utility service or a different utility service; communicating energy from the second single-phase AC power source to the propulsion DC battery pack of the EV; and communicating DC power from the propulsion DC battery pack to a propulsion DC battery pack of a third EV, which is to be charged.

In some other embodiments, the foregoing method 36 may further comprise the step of communicating energy to the power grid or to a building situated in close proximity of the first EV from the first DC battery pack of the first EV.

### Variations and Modifications

Finally, it should be emphasized that the above-described embodiment(s) of the present invention is merely a possible nonlimiting example of an implementation, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

At least the following is claimed:

1. A charging system for charging electric vehicles (EVs), the system comprising at least:
(a) an EV having:
(1) an electric propulsion, direct current (DC) battery pack with a plurality of batteries, the battery pack designed to provide electrical power to a plurality of electric motors for propulsion of the EV;
(2) a DC charging port that is connected to the DC battery pack;
(3) an alternating current (AC) charging port, the AC charging port connected to a single-phase AC power grid associated with a utility service provider, the AC charging port capable of receiving AC power from the AC power grid; and
(4) an AC to DC converter, the converter connected to the AC charging port and the battery pack and capable of providing DC power to the battery pack from the AC power grid; and
(b) a point-of-sale (PoS) dispenser connected to and for receiving DC power from the DC charging port, the dispenser having a coupler that is connectable to and dis-connectable from an EV to be charged.

2. The system of claim 1, wherein the AC port is capable of providing AC power to the AC power grid from DC power from the converter and the battery pack.

3. The system of claim 1, further comprising the EV to be charged and that is connected to the DC charging port, wherein the AC power that is provided by the AC power grid is power limited to less than 50 kilowatts (KW), and wherein the DC power that is provided to the battery pack is at least 50 kW.

4. The system of claim 1, further comprising at least one supplemental DC battery pack having a plurality of batteries, the supplement DC battery pack being connected in parallel with the propulsion DC battery pack.

5. The system of claim 4, further comprising a stand upon which the EV rests for elevating the EV and wherein the supplemental DC battery pack is situated under the EV.

6. The system of claim 1, further comprising a housing, the housing having an interior within which the EV resides and an exterior, the PoS dispenser being situated on the exterior.

7. The system of claim 1, wherein the EV further comprises a combined charging system (CCS) port that includes both the DC and AC charging ports.

8. The system of claim 7, further comprising a splitter that physically mounts on the CCS port and that electrically separates the DC and AC charging ports.

9. A charging system for charging electric vehicles (EVs), the system comprising at least:
(a) an EV having:
(1) an electric propulsion, direct current (DC) battery pack with a plurality of batteries, the battery pack designed to provide electrical power to a plurality of electric motors for propulsion of the EV;
(2) a combined charging system (CCS) port having DC and alternating current (AC) charging ports, the DC charging port connected to the DC battery pack, the AC charging port connected to a single-phase AC power grid associated with a utility service provider, the AC charging port receiving AC power from the AC power grid, the AC power being power limited to less than 50 kilowatts (KW) by the utility service provider; and
(3) an on-board charger module (OBCM), the OBCM connected to the AC charging port and the battery pack and providing DC power to the battery pack from the AC power grid, the DC power measuring at least 50 KW; and
(b) a point-of-sale (PoS) dispenser connected to and for receiving DC power from the DC charging port, the dispenser having a coupler that is connectable to and dis-connectable from an EV to be charged.

10. The system of claim 9, wherein the AC port is capable of providing AC power to the AC power grid from DC power from the converter and the battery pack.

11. The system of claim 9, further comprising the EV to be charged and that is connected to the DC charging port.

12. The system of claim 9, further comprising at least one supplemental DC battery pack having a plurality of batteries, the supplement DC battery pack being connected in parallel with the propulsion DC battery pack.

13. The system of claim 12, further comprising a stand upon which the EV rests for elevating the EV and wherein the supplemental DC battery pack is situated under the EV.

14. The system of claim 13, further comprising a stand upon which the EV rests for elevating the EV and wherein the supplemental DC battery pack is situated under the EV.

15. The system of claim 9, wherein the EV further comprises a combined charging system (CCS) port that includes both the DC and AC charging ports.

16. The system of claim 15, further comprising a splitter that physically mounts on the CCS port and that electrically separates the DC and AC charging ports.

17. A system for charging an electric vehicle (EV), the system comprising:
means for providing first and second EVs at a location and access to a single-phase alternating current (AC) power grid provided by a utility service provider;
means for communicating energy from the AC power grid to a first propulsion, direct current (DC) battery pack of the first EV; and
means for communicating DC power from the first propulsion DC battery pack to a second propulsion DC battery pack of the second EV, which is to be charged.

18. A method for charging an electric vehicle (EV), the method comprising at least the steps of:
providing first and second EVs at a location and access to a single-phase alternating current (AC) power grid provided by a utility service provider;
communicating energy from the AC power grid to a first propulsion, direct current (DC) battery pack of the first EV; and
communicating DC power from the first propulsion DC battery pack to a second propulsion DC battery pack of the second EV, which is to be charged.

19. The method of claim 18, wherein the AC power that is provided by the AC power grid is power limited to less than 50 kilowatts (KW), wherein the DC power that is provided to the battery pack is at least 50 KW, and further the steps of:
providing a supplemental propulsion DC battery pack at the location; and
communicating DC power from the supplemental propulsion DC battery pack to the second propulsion DC battery pack of the second EV.

20. The method of claim 18, further comprising the steps of:
disconnecting the EV from the AC power source provided by the utility service;
driving the EV to a new location;
connecting the EV to a second single-phase AC power source provided by the utility service or a different utility service;
communicating energy from the second single-phase AC power source to the propulsion DC battery pack of the EV; and
communicating DC power from the propulsion DC battery pack to a propulsion DC battery pack of a third EV, which is to be charged.

21. The method of claim 18, further comprising the step of communicating energy to the power grid or to a building situated in close proximity of the first EV from the first DC battery pack of the first EV.
